(19) United States
(12) Patent Application Publication
(10) Pub. No.: US 2025/0363190 A1
(43) Pub. Date: Nov. 27, 2025

(54) GENERATION AND MANAGEMENT OF TRAINING AND TUNING DATA FOR ARTIFICIAL INTELLIGENCE SYSTEMS

(71) Applicant: Thomas Patrick Suhadolnik, Concord, OH (US)

(72) Inventor: Thomas Patrick Suhadolnik, Concord, OH (US)

(21) Appl. No.: 19/218,243

(22) Filed: May 24, 2025

Related U.S. Application Data
(60) Provisional application No. 63/651,983, filed on May 25, 2024.

(51) Int. Cl. G06F 21/10

(52) U.S. Cl. CPC G06F 21/105; G06F 21/1078

(57) ABSTRACT

Systems and methods are provided for management of inference augmentation data for artificial intelligence systems. An owner of a plurality of media objects is allowed to upload the plurality of media objects to a local data repository, and a dataset comprising the plurality of data objects each containing a high-dimensional vector representation of a content of a corresponding media object of the plurality of media objects. A user operating an artificial intelligence system licenses a dataset with a set of usage rights, and the artificial intelligence systems is selectively allowed to access the dataset according to a set of usage rights.

### RELATED APPLICATIONS

This application claims priority to U.S. Provisional Patent No. 63/651,983, filed May 25, 2024, and entitled “Systems and Methods for Licensing and Management of Copyrighted Content for use in Artificial Intelligence,” which is hereby incorporated by reference in its entirety.

### TECHNICAL FIELD

This invention relates to artificial intelligence systems, and more particularly, to the generation and management of training and tuning data for artificial intelligence systems.

### BACKGROUND

Large language models (LLMs) and similar artificial intelligence systems generally work in two modes: training and inference. When an LLM operates in training mode, large quantities of data, such as text, images, audio recordings, mathematical numerical data, and other data available in a machine-readable format, are converted into mathematical tokens representing the data. The tokens are grouped and algorithmically processed by the LLM in a manner that “trains” the LLM to have the ability to associate specific tokens, or groups of specific tokens, with other tokens. The more data used to train the LLM, the better the LLM's ability to associate tokens with each other.

When the LLMs operate in inference mode, a user or another system passes data to the LLM in the form of a query. The LLM converts the query data into tokens, algorithmically processes those tokens, and then returns a response message containing tokens that have the highest mathematical probability of being associated with the tokens passed in the original query.

If an LLM trained on general text data found on Wikipedia or some other body of text representing general knowledge were passed a query “What are the four suits in a deck of cards?”, the LLM would convert the query into tokens, process the tokens, and likely return a response containing “clubs”, “hearts”, “diamonds” and “spades.” The LLM can do this because it has been trained to associate “suits” and “cards” with “clubs”, “hearts”, “diamonds” and “spades.” LLMs require large amounts of data to be trained to make these probabilistic determinations.

Organizations and individuals have historically procured the data used to train LLMs by collecting, downloading, or scraping data from the Internet. Although the data is almost always copyrighted, these organizations and individuals rarely obtain permission from copyright holders. This practice has placed these LLMs and their creators in legal jeopardy as the LLMs could considered an adaptation of the copyrighted work, and the LLMs themselves the product of copyright infringement.

Only the owner of copyright in a work has the right to prepare, or to authorize someone else to create, an adaptation of that work. The owner of a copyright is generally the author or someone who has obtained the exclusive rights from the author. In any case where a copyrighted work is used without the permission of the copyright owner, copyright protection will not extend to any part of the work in which such material has been used unlawfully. The unauthorized adaptation of a work may constitute copyright infringement.

Recently, large organizations have begun to license copyrighted material from large organizations that own the copyright for training data. This approach requires manual negotiation and collection of licensing fees. While suitable for large quantities of general data, this approach is not commercially feasible for licensing data from the vast majority of smaller organizations and authors that own the copyright to smaller, specialized training data sets. For these smaller, specialized training data sets, the transaction costs associated with negotiation, licensing, and payment collection can often exceed the value of the training data itself. This leaves the individuals and organizations training the LLMs (hereinafter “Data Consumers” or “Consumers”) in the difficult position of choosing between copyright infringement or forgoing the use of specialized training data sets. It also leaves the copyright holders (hereinafter “Data Owners” or “Owners”) without an economically viable way to license their data for use in LLMs.

### SUMMARY OF THE INVENTION

In one implementation, a system includes a processor, a network interface, and a non-transitory computer readable medium storing instructions executable by a processor to manage a database of inference augmentation data for artificial intelligence systems. The instructions include a user interface that allows a user to licensing a set of usage rights for a dataset of a plurality of datasets stored in the database of inference augmentation data. An access control system that selectively allows an artificial intelligence system operated by the user to access the dataset according to the set of usage rights. Each dataset in the database of inference augmentation data includes a plurality of data files each containing a high-dimensional vector representation of a content of a media object.

In another implementation, a method is provided. An owner of a plurality of media objects is allowed to upload the plurality of media objects to a local data repository, and a dataset comprising the plurality of data objects each containing a high-dimensional vector representation of a content of a corresponding media object of the plurality of media objects. A user operating an artificial intelligence system licenses a dataset with a set of usage rights, and the artificial intelligence systems is selectively allowed to access the dataset according to a set of usage rights.

In a further implementation, a system includes a processor, a network interface, and a non-transitory computer readable medium storing instructions executable by a processor to manage a database of inference augmentation data for an artificial intelligence system. The instructions include a user interface that allows a user to license a set of usage rights for the artificial intelligence system to a dataset of a plurality of datasets stored in the database of inference augmentation data. Each of the plurality of datasets comprising high-dimensional vector representations of a content of a plurality of media objects and a set of unique and identifiable data that was not present in the plurality of media objects. An access control system selectively allows the artificial intelligence system to access the dataset according to the set of usage rights.

### BRIEF DESCRIPTION OF THE DRAWINGS

The foregoing and other features of the present disclosure will become apparent to those skilled in the art to which the present disclosure relates upon reading the following description with reference to the accompanying drawings, in which:

FIG. 1 illustrates one example of a system for management of inference augmentation data for artificial intelligence systems;

FIG. 2 Illustrates a functional block diagram of one example of a system for the storage, transformation, licensing, distribution, protection, consumption, metering, and collection and disbursement of payments related to data used to train artificial intelligence systems;

FIG. 3 illustrates a block diagram showing an example implementation of the data transformation component of FIG. 2;

FIG. 4 illustrates a method for management of inference augmentation data for artificial intelligence systems; and

FIG. 5 is a schematic block diagram illustrating an exemplary system of hardware components capable of implementing examples of the systems and methods disclosed herein.

### DETAILED DESCRIPTION

In the context of the present disclosure, the singular forms “a,” “an” and “the” can also include the plural forms, unless the context clearly indicates otherwise. The terms “comprises” and/or “comprising,” as used herein, can specify the presence of stated features, steps, operations, elements, and/or components, but do not preclude the presence or addition of one or more other features, steps, operations, elements, components, and/or groups.

As used herein, the term “and/or” can include any and all combinations of one or more of the associated listed items.

Additionally, although the terms “first,” “second,” etc. may be used herein to describe various elements, these elements should not be limited by these terms. These terms are only used to distinguish one element from another. Thus, a “first” element discussed below could also be termed a “second” element without departing from the teachings of the present disclosure. The sequence of operations (or acts/steps) is not limited to the order presented in the claims or figures unless specifically indicated otherwise.

“Inference augmentation data,” as used herein, is data that can be retrieved using an initial prompt to a large language model and added to the initial prompt to add context in a final prompt provided to the model, for example, as part of a retrieval augmented generation process.

As used herein, the term “substantially identical” or “substantially equal” refers to articles or metrics that are identical other than measurement error.

As used herein, a “media object” can include any of text, images, audio recordings, video, and numerical data.

A “size” of a media object refers to the size of a digital file representing the object. It will be appreciated that, when objects are stored in standard formats within a database, this will correlate with the amount of content within the file, such as the length of a segment of text, video, or audio file.

An “artificial intelligence system” is a system that performs complex tasks without significant human oversight. As used herein, artificial intelligence systems can include both classifiers and generative artificial intelligence systems, such as large language models (LLMs).

The present disclosure is related to various embodiments of systems and methods that combine software, computer algorithms, computer networks and access to electronic payment systems for use in the storage, transformation, licensing, distribution, protection, consumption, metering, and collection and disbursement of payments related to data used to train artificial intelligence systems. The data can be text, images, audio recordings, mathematical numerical data, and any other structured or unstructured information available in a machine-readable format, referred to generally throughout as media objects. The systems and methods described herein provide an automated, economically feasible means to license, distribute, protect, consume, meter, collect, and disburse payments related to copyrighted data used to train LLMs. The illustrated systems and methods allow copyrighted data to be used by LLMs operating in inference mode, thereby avoiding the need for tuning or advanced training. This can reduce the cost and energy necessary to produce a large language model by several orders of magnitude.

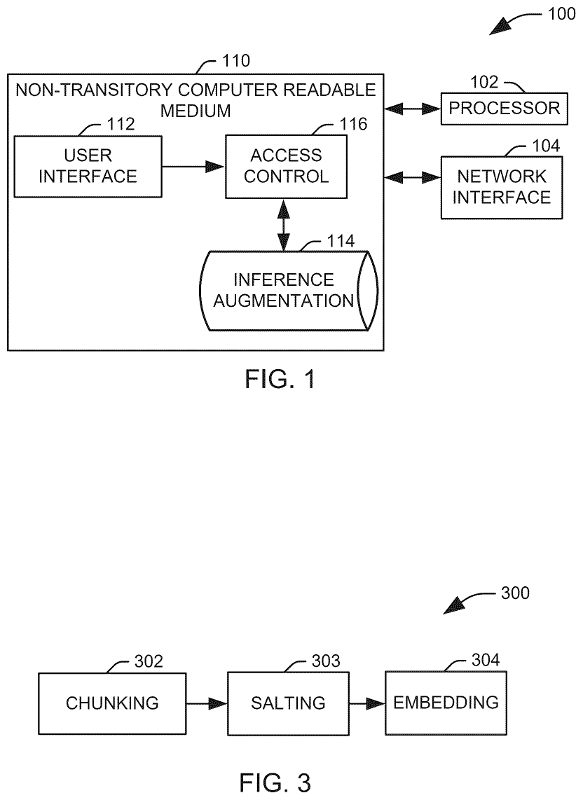

FIG. 1 illustrates one example of a system 100 for management of inference augmentation data for artificial intelligence systems. The system 100 includes a processor 102, a network interface 104, and a non-transitory computer readable medium 110 storing instructions executable by a processor to manage a database of inference augmentation data for artificial intelligence systems. The executable instructions include a user interface 112 that allows a user to license a set of usage rights for an artificial intelligence system to access a dataset of a plurality of datasets stored in the database of inference augmentation data 114. Each dataset in the database of inference augmentation data 114 includes a plurality of data objects each containing a high-dimensional vector representation of the content of a media object. In one example, each data object can include both a portion of the content of the media object (e.g., a chunk of text) and a high-dimensional vector representation of that portion of the media object. The usage rights associated with each dataset can include any of a set of datasets that can be accessed by the artificial intelligence system, a maximum number of unique accesses to the datasets accessible by the artificial intelligence system, a number of unique accesses available for each dataset, a maximum amount of data accessible from the database 114, and a maximum amount of data accessible for each dataset.

In one example, an embedding component (not shown) generates the plurality of data objects from a corresponding plurality of media objects stored in a local data repository (not shown). The user interface 112 can allow owners of media content to upload media files used to generate media objects to the local data repository. It will be appreciated that artificial intelligence systems require media objects to be embedded into this vector representation as part of the process of training and tuning the system, and this process is resource-intensive. By storing the data in this form, the embedding process can be performed once to generate datasets used to operate multiple systems in inference mode on the same dataset, greatly reducing the cost and energy needed for training these systems over conventional approaches.

In one implementation, the media objects can represent segments of larger media files, and a given media file can be represented in multiple datasets as chunks of different sizes. For example, one dataset might include high-dimensional vector representations of the content of a first set of media objects with a specific chunk size and a second dataset comprising high-dimensional vector representations of the content of a second set of media objects within a second specific chunk size. In some implementations, multiple chunk sizes can be used for a given media object. Further, the dataset can be supplemented with unique and identifiable data that was not originally present in the media objects represented by the dataset. By “unique and identifiable,” it is meant that an artificial intelligence system trained on or otherwise accessing a dataset incorporating this dataset will respond to queries in a predictable fashion that differs from a machine learning system trained on an otherwise identical dataset that does not incorporate this data. Accordingly, artificial intelligence systems trained or tuned on the dataset or operating in inference mode from the stored dataset can be readily identified even once the unique and identifiable data has been embedded into a high-dimensional vector representation.

An access control system 116 selectively allows the artificial intelligence system to access the dataset according to the set of usage rights. For example, the access control system 116 can allow the artificial intelligence system access only to a set of datasets for which access rights have been acquired and limit the overall number of accesses or amount of data accessed. In one implementation, the access control system monitors a number of times that the dataset has been accessed by the artificial intelligence system, for example, to determine a cost for accessing the data. Additionally or alternatively, the access control system can compare the number of times that the dataset has been accessed by the artificial intelligence system to a threshold value defined by the set of access rights and deny access to the dataset if the number of times that the dataset has been accessed by the artificial intelligence system meets the threshold value.

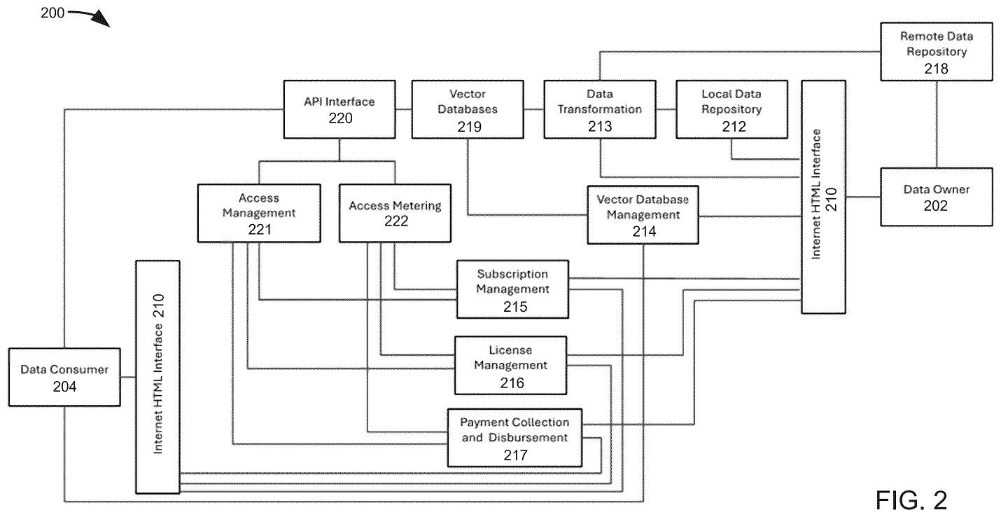

FIG. 2 Illustrates a functional block diagram of one example of a system 200 for the storage, transformation, licensing, distribution, protection, consumption, metering, and collection and disbursement of payments related to data used to train artificial intelligence systems. It will be appreciated that various components of the system 210-222 can be implemented using appropriate computer hardware, software, and algorithms, for example, as described in FIG. 5 herein. A Data Owner 202 represents the person, organization, or computer system that owns the copyright to the inference augmentation data made available through the system. A Data Consumer 204 represents the person, organization, or computer system that wishes to utilize the inference augmentation data. The data owner can interact with the system through a user interface implemented as Internet HTML interface 210. The interface 210 allows the data owner 202 to interact with other components of the system, including a local data repository 212, a data transformation component 213, a vector database management 214, a subscription management component 215, a licensing management component 216, and a payment collection and disbursement component 217.

The local data repository 212 comprises appropriate computer hardware, software, and algorithms to allow inference augmentation data to be stored inside the system and to be used by other components. The data transformation component 213 transforms raw media objects into a format appropriate for LLMs. The remote data repository 218 stores inference augmentation data outside of the system but can be accessed by the system 200 and transformed at the data transformation component 213. The vector databases 219 store the inference augmentation data in vector databases or similar technology. The vector databases 219 allow LLMs to access the data when the LLMs are operating in inference mode. The inference augmentation data stored in the vector databases 219 will include a high-dimensional-dense-vector representation of the semantic meaning of fragments of media objects. LLMs can programmatically access this high-dimensional vector representation as well as chunks of media objects via an application program interface (API interface) 220 while operating in inference mode, thereby eliminating the need for traditional LLM training. Access is controlled and metered to ensure prospering licensing and compensation to the Data Owner 202 from the Data Consumer 204.

The vector database management component 214 can publish, update, merge, and delete individual vector databases representing sets of media objects. The API interface 220 allows external LLMs to access transformed media objects in vector databases 219. The vector database management 214 allows Data Owners 202, or groups of Data Owners, to compile a single vector database compromising multiple sources that act as a “collection” of related information to Data Consumers 204 and their associated LLMs. The API interface 220 also interacts with access management 221 and metering 222 components. The access management component 221, among other functions, verifies that only Data Consumers 204 with an active subscription to a particular data set can query the vector databases 219 via the API Interface 220. The access metering component 222, among other functions, monitors and records what data sets are accessed by a particular Data Consumer 204 so that the Data Consumer can be billed for accessing the data set.

The subscription management component 215 manages data sets made available by Data Owners 202 to Data Consumers 204. The subscription management component 215 also interacts with the access management 221 and access metering 222 components to inform those systems that a Data Consumer 204 is allowed access to certain data sets, which Data Consumer should be billed for access, and which Data Owner 202 should be credited for access to the data. Data Consumers 204 and Data Owners 202 interact with the subscription management component via the Internet HTML Interface 210. Data Owners 202 make data sets available to Data Consumers 204 by publishing them at the subscription management component 215. Data Consumers 204 subscribe to data sets using the same system.

The license management component 216 is used to manage the terms and conditions which data sets can be accessed by Data Consumers 204. Data Owners 202 can set conditions such as a maximum number of discrete accesses, cost per discrete access, cost per month, and minimum cost. Data Owners 202 can also restrict access to LLMs operating in inference mode, thereby preventing the training data from being embedded in the LLM. The license management component 216 also interacts with the access management 221 and access metering 222 components to inform those systems what type of access can be granted to data sets. Data Consumers 204 can review, accept, or negotiate these terms with Data Owners 202. Once a Data Owner 202 and Data Consumer 204 agree to terms, they can confirm their agreement using the license management component 216. Data Consumers 204 and Data Owners 202 interact with the license management component 216 via the Internet HTML Interface 210.

The payment collection and disbursement component 217 is used to collect funds from Data Consumers 204 and disburse payments to Data Owners 202 per the terms of the licensing agreement. Configuration changes to the payment collection and disbursement 217 are made through the Internet HTML Interface 210. The payment collection and disbursement 217 is also connected to the access management 221 and access metering 222 components to help it determine what payments to collect and disburse.

FIG. 3 illustrates a block diagram showing an example implementation 300 of the data transformation component 213 of FIG. 2. It will be appreciated that various components 302-304 of this example implementation 300 of the data transformation component 213 can be implemented using appropriate computer hardware, software, and algorithms, for example, as described in FIG. 5 herein. A chunking component 302 divides data files from either the remote data repository 218 or the local data repository 212 into fragments of uniform size, in a process known as “chunking.” Each data file is broken into several different temporary files made up of different chunk sizes. For example, one set of chunks could contain media objects split into paragraphs, one set of chunks could include chunks two hundred characters long, and another set of chunks could contain all graphic images contained in the original file.

A license salting component 303 adds unique and identifiable information to the database storing the set of chunks. For example, a nonsense phrase and an identifiable sequence, such as a license key, can be added to the vector database. This unique and identifiable information, known as a “salt”, is stored in the vector databases 219 and the licensing management component 216. If an LLM is trained to retain training data, and that training violates the terms of the licensing agreement between the Data Owner 202 and the Data Consumer 204, this “salt” will be embedded in the LLM during the training phase. The LLM can later be queried for the salted information to prove copyright infringement.

An embedding component 304 creates a high-dimensional, dense vector representation of the chunk's semantic meaning. Using different algorithms, the embedding component 304 can create more than one vector representation for each chunk. Accordingly, the embedding component can create one vector database of the vector database 219 for each chunk size and embedding algorithm combination. Each vector database is accessible through the API Interface 220 by specifying the embedding algorithm, chunk size, and set of media objects, which will be available via the Internet HTML Interface 210, the API Interface, and the subscription management component 215.

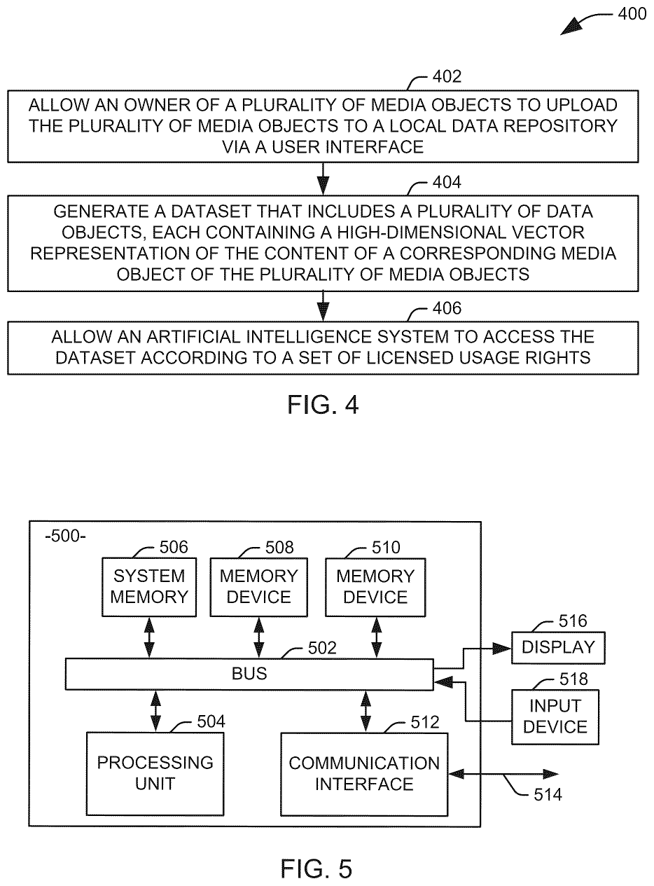

In view of the foregoing structural and functional features described above, example methods will be better appreciated with reference to FIG. 4. While, for purposes of simplicity of explanation, the example methods of FIG. 4 are shown and described as executing serially, it is to be understood and appreciated that the present examples are not limited by the illustrated order, as some actions could in other examples occur in different orders, multiple times and/or concurrently from that shown and described herein. Moreover, it is not necessary that all described actions be performed to implement a method.

FIG. 4 illustrates a method 400 for management of inference augmentation data for artificial intelligence systems. At 402, an owner of a plurality of media objects is allowed to upload the plurality of media objects to a local data repository via a user interface. At 404, a dataset is generated that includes a plurality of data objects, each containing a high-dimensional vector representation of the content of a corresponding media object of the plurality of media objects. In one example, a first dataset, comprises high-dimensional vector representations of the content of the set of media objects within a first chunk size range, and a second dataset comprises high-dimensional vector representations of the content of the same set of media objects and chunked into a second size range, are generated such that the second size range overlaps the first size range. It will be appreciated that the dataset can also include the chunked content itself, such that the high-dimensional vector representation can be used to retrieve a chunk of content that is according to a provided prompt. Additionally or alternatively, a set of unique and identifiable data can be added to the plurality of media objects, such that a high-dimensionality vector representation of the set of unique and identifiable data is included in the dataset.

At 406, a user operating an artificial intelligence system licenses a dataset for the artificial intelligence system according to a set of usage rights. The usage rights associated with each dataset can include any of a set of datasets that can be accessed by the artificial intelligence system, a maximum number of unique accesses to the datasets accessible by the artificial intelligence system, a number of unique accesses available for each dataset, a maximum amount of data accessible from the database, and a maximum amount of data accessible for each dataset. At 408, an artificial intelligence system is allowed to access the dataset according to the set of usage rights. In one example, a number of times that the dataset has been accessed by the artificial intelligence system can be monitored and used to determine a cost for access to the data. In another example, a user can purchase a number of unique accesses as part of the usage rights. In this implementation, the number of times that the dataset has been accessed by the artificial intelligence system can be compared to a threshold value defined by the set of access rights, specifically the purchased numbers of accesses, and access to the dataset can be denied if the number of times that the dataset has been accessed by the artificial intelligence system meets the threshold value.

FIG. 5 is a schematic block diagram illustrating an exemplary system 500 of hardware components capable of implementing examples of the systems and methods disclosed herein. The system 500 can include various systems and subsystems. The system 500 can be a personal computer, a laptop computer, a workstation, a computer system, an appliance, an application-specific integrated circuit (ASIC), a server, a server BladeCenter, a server farm, etc.

The system 500 can include a system bus 502, a processing unit 504, a system memory 506, memory devices 508 and 510, a communication interface 512 (e.g., a network interface), a communication link 514, a display 516 (e.g., a video screen), and an input device 518 (e.g., a keyboard, touch screen, and/or a mouse). The system bus 502 can be in communication with the processing unit 504 and the system memory 506. The additional memory devices 508 and 510, such as a hard disk drive, server, standalone database, or other non-volatile memory, can also be in communication with the system bus 502. The system bus 502 interconnects the processing unit 504, the memory devices 506-510, the communication interface 512, the display 516, and the input device 518. In some examples, the system bus 502 also interconnects an additional port (not shown), such as a universal serial bus (USB) port.

The processing unit 504 can be a computing device and can include an application-specific integrated circuit (ASIC). The processing unit 504 executes a set of instructions to implement the operations of examples disclosed herein. The processing unit can include a processing core.

The additional memory devices 506, 508, and 510 can store data, programs, instructions, database queries in text or compiled form, and any other information that may be needed to operate a computer. The memories 506, 508 and 510 can be implemented as computer-readable media (integrated or removable), such as a memory card, disk drive, compact disk (CD), or server accessible over a network. In certain examples, the memories 506, 508 and 510 can comprise text, images, video, and/or audio, portions of which can be available in formats comprehensible to human beings. Additionally or alternatively, the system 500 can access an external data source or query source through the communication interface 512, which can communicate with the system bus 502 and the communication link 514.

In operation, the system 500 can be used to implement one or more parts of a system in accordance with the present invention. Computer executable logic for implementing the diagnostic system resides on one or more of the system memory 506, and the memory devices 508 and 510 in accordance with certain examples. The processing unit 504 executes one or more computer executable instructions originating from the system memory 506 and the memory devices 508 and 510. The term “computer readable medium” as used herein refers to a medium that participates in providing instructions to the processing unit 504 for execution. This medium may be distributed across multiple discrete assemblies all operatively connected to a common processor or set of related processors.

Implementation of the techniques, blocks, steps, and means described above can be done in various ways. For example, these techniques, blocks, steps, and means can be implemented in hardware, software, or a combination thereof. For a hardware implementation, the processing units can be implemented within one or more application specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, other electronic units designed to perform the functions described above, and/or a combination thereof.

Also, it is noted that the embodiments can be described as a process which is depicted as a flowchart, a flow diagram, a data flow diagram, a structure diagram, or a block diagram. Although a flowchart can describe the operations as a sequential process, many of the operations can be performed in parallel or concurrently. In addition, the order of the operations can be re-arranged. A process is terminated when its operations are completed, but could have additional steps not included in the figure. A process can correspond to a method, a function, a procedure, a subroutine, a subprogram, etc. When a process corresponds to a function, its termination corresponds to a return of the function to the calling function or the main function.

Furthermore, embodiments can be implemented by hardware, software, scripting languages, firmware, middleware, microcode, hardware description languages, and/or any combination thereof. When implemented in software, firmware, middleware, scripting language, and/or microcode, the program code or code segments to perform the necessary tasks can be stored in a machine readable medium such as a storage medium. A code segment or machine-executable instruction can represent a procedure, a function, a subprogram, a program, a routine, a subroutine, a module, a software package, a script, a class, or any combination of instructions, data structures, and/or program statements. A code segment can be coupled to another code segment or a hardware circuit by passing and/or receiving information, data, arguments, parameters, and/or memory contents. Information, arguments, parameters, data, etc. can be passed, forwarded, or transmitted via any suitable means including memory sharing, message passing, ticket passing, network transmission, etc.

For a firmware and/or software implementation, the methodologies can be implemented with modules (e.g., procedures, functions, and so on) that perform the functions described herein. Any machine-readable medium tangibly embodying instructions can be used in implementing the methodologies described herein. For example, software codes can be stored in a memory. Memory can be implemented within the processor or external to the processor. As used herein the term “memory” refers to any type of long term, short term, volatile, nonvolatile, or other storage medium and is not to be limited to any particular type of memory or number of memories, or type of media upon which memory is stored.

Moreover, as disclosed herein, the term “storage medium” can represent one or more memories for storing data, including read only memory (ROM), random access memory (RAM), magnetic RAM, core memory, magnetic disk storage mediums, optical storage mediums, flash memory devices and/or other machine readable mediums for storing information. The term “machine-readable medium” includes, but is not limited to portable or fixed storage devices, optical storage devices, wireless channels, and/or various other storage mediums capable of storing that contain or carry instruction(s) and/or data.

What have been described above are examples. It is, of course, not possible to describe every conceivable combination of components or methodologies, but one of ordinary skill in the art will recognize that many further combinations and permutations are possible. Accordingly, the disclosure is intended to embrace all such alterations, modifications, and variations that fall within the scope of this application, including the appended claims. As used herein, the term “includes” means includes but not limited to, the term “including” means including but not limited to. The term “based on” means based at least in part on.

What is claimed is:

1. A system comprising:
a processor;
a network interface; and
a non-transitory computer readable medium storing instructions executable by a processor to manage a database of inference augmentation data for artificial intelligence systems, the instructions comprising:
a user interface that allows a user to licensing a set of usage rights for a dataset of a plurality of datasets stored in the database of inference augmentation data; and
an access control system that selectively allows an artificial intelligence system operated by the user to access the dataset according to the set of usage rights;
wherein each dataset in the database of inference augmentation data includes a high-dimensional vector representation of a content of at least one media object.

2. The system of claim 1, the executable instructions further comprising a license management component that allows a data owner to set terms for licensing the usage rights for the dataset.

3. The system of claim 1, wherein the license management component allows the data owner to set at least one of a maximum number of discrete accesses for the dataset, a cost per discrete access for the dataset, a cost per month for the dataset, and a minimum cost for the dataset.

4. The system of claim 1, wherein each dataset includes unique and identifiable data that was not originally present in the at least one media object represented by the dataset.

5. The system of claim 1, wherein the access control system restricts access to the dataset to artificial intelligence systems operating in inference mode.

6. The system of claim 1, the executable instructions further comprising an access metering component that monitors a number of times that the dataset has been accessed by the artificial intelligence system.

7. The system of claim 6, wherein the access metering component compares the number of times that the dataset has been accessed by the artificial intelligence system to a threshold value defined by the set of access rights and denies access to the dataset if the number of times that the dataset has been accessed by the artificial intelligence system meets the threshold value.

8. The system of claim 6, wherein the access metering component determines a cost for accessing the database from the number of times that the dataset has been accessed by the artificial intelligence system.

9. A method comprising:
allowing an owner of a plurality of media objects to upload the plurality of media objects to a local data repository;
generating a dataset containing a high-dimensional vector representation of each of the plurality of media objects;
allowing a user operating an artificial intelligence to license the set of usage rights at a user interface, the set of usage rights defining the access of the artificial intelligence system to the dataset; and
selectively allowing the artificial intelligence system to access the dataset according to a set of usage rights.

10. The method of claim 9, further comprising adding a set of unique and identifiable data to the plurality of media objects, such that a high-dimensionality vector representation of the set of unique and identifiable data is included in the dataset.

11. The method of claim 9, the set of usage rights including at least one of a maximum number of discrete accesses for the dataset, a cost per discrete access for the dataset, a cost per month for the dataset, and a minimum cost for the dataset.

12. The method of claim 9, further comprising monitoring a number of times that the dataset has been accessed by the artificial intelligence system.

13. The method of claim 12, further comprising determining a cost for accessing the database from the number of times that the dataset has been accessed by the artificial intelligence system.

14. The method of claim 12, further comprising:
comparing the number of times that the dataset has been accessed by the artificial intelligence system to a threshold value defined by the set of access rights; and
denying access to the dataset if the number of times that the dataset has been accessed by the artificial intelligence system meets the threshold value.

15. A system comprising:
a processor;
a network interface; and
a non-transitory computer readable medium storing instructions executable by a processor to manage a database of inference augmentation data for an artificial intelligence system, the instructions comprising:
a user interface that allows a user to license a set of usage rights for the artificial intelligence system to a dataset of a plurality of datasets stored in the database of inference augmentation data, each of the plurality of datasets comprising high-dimensional vector representations of a content of a plurality of media objects and a set of unique and identifiable data that was not present in the plurality of media objects; and
an access control system that selectively allows the artificial intelligence system to access the dataset according to the set of usage rights.

16. The system of claim 15, the database of inference augmentation data comprising a first dataset comprising high-dimensional vector representations of the content of a first set of media objects within a first size range and a second dataset comprising high-dimensional vector representations of the content of a second set of media objects within a second size range that does not overlap the first size range.

17. The system of claim 15, wherein the user interface allows an owner of the plurality of media objects to set terms for licensing the usage rights for the dataset, the terms including at least one of a maximum number of discrete accesses for the dataset, a cost per discrete access for the dataset, a cost per month for the dataset, and a minimum cost for the dataset.

18. The system of claim 15, wherein the access control system monitors a number of times that the dataset has been accessed by the artificial intelligence system.

19. The system of claim 18, wherein the access control system compares the number of times that the dataset has been accessed by the artificial intelligence system to a threshold value defined by the set of access rights and denies access to the dataset if a number of times that the dataset has been accessed by the artificial intelligence system meets the threshold value.

20. The system of claim 15, the executable instructions further comprising:
a local data repository that stores the plurality of media objects; and
an embedding component that generates the plurality of data files from the plurality of media objects;
wherein the user interface allows an owner of a media object of the plurality of media objects to add media objects to the local data repository.
